(19) United States
(12) Patent Application Publication
(10) Pub. No.: US 2012/0104818 A1
(43) Pub. Date: May 3, 2012

(54) Portable, Powered Chair Lift

(76) Inventor: Dennis Kimble Morris, Coleman, FL (US)

(21) Appl. No.: 13/097,893

(22) Filed: Apr. 29, 2011

Related U.S. Application Data
(60) Provisional application No. 61/330,066, filed on Apr. 30, 2010.

(51) Int. Cl. A61G 7/10

(52) U.S. Cl. 297/316

(57) ABSTRACT

A portable, powered lifting chair provides a means with which to easily lift and transport a fallen person, with safety for both the fallen person and the attendant. A single attendant can operate the present invention, negating the need for multiple attendants to lift a single person. The lifting seat is battery powered allowing for remote operation and, when combined with a variable speed hand controller, allows for an adjustable lifting speed suitable for any scenario. The seat lifts to a height of 39″, allowing it to be used to not only transport patients to a bed or a chair, but also to transition them from a prone position to a standing position. The combination of linear bearings, linear rail, and a linear actuator attached directly between the lifting seat and the seat frame serve to ensure the lifting seat does not become misaligned or improperly tilted during use. With the frame on casters, it is highly maneuverable and able to be used in tight confines.

### CROSS-REFERENCE TO RELATED APPLiCATiONS

This non-provisional application claims the benefit of provisional application 61/330,066, titled “A portable, electric powered mechanical elevator chair lift which hoists a fallen non-ambulatory person from floor”, filed with the United States Patent and Trademark Office on Apr. 30, 2010 (Apr. 30, 2010).

### STATEMENT REGARDNG FEDERALlY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

According to the Center for Disease Control (CDC), each year, one third of all adults age 65 or older experience a fall. While this statistic may not seem overwhelming, when coupled with the fact that falls are the leading cause of fatal and non-fatal injuries for persons aged 65 or older it carries new meaning. In 2000, direct medical costs for fall-related injuries totaled over $19 billion. With a surge in adults age 65 or older looming, it is likely that the number of falls and the cost to treat the falls will rise dramatically in coming years. In addition to the effect falling has directly on the “victim”, there may also be additional injuries sustained to the fallen person and to those attempting to right the fallen person when the fallen person is manually lifted. Workers Compensation claims for nurses in assisted care facilities account for a disproportionate amount of the medical claims annually. On average, a 100-bed facility reports 100 to 200 falls annually (these are only the reported falls). Nearly all of these falls require additional assistance from a caregiver to assist the patient in standing.

A countless number of non-ambulatory people require the assistance of loved ones or full-time caretakers to carry on with day-to-day tasks. While these non-ambulatory people seek as much independence and freedom as possible, fear of falling sets many necessary limits on allowable physical activity, greatly restricting their independence. Many caretakers do not have the necessary strength or know appropriate physical lifting techniques to aid a fallen patient in the event a fall occurs. A fall often requires a person to remain on the floor for an extended period of time, while the caretaker waits for additional help to arrive to right the fallen person. Falls result in added fears of inability to provide necessary care for their patient, further limiting the patient's freedom and independence.

Much prior art has been dedicated to finding a viable solution to the problem of lifting a non-ambulatory person from the floor. A large number of the disclosed inventions have drawbacks, which severely limit the range, functionality, and practicality of these inventions. For example, the invention disclosed in U.S. Pat. No. 4,296,509 states that it is portable. While this device can be broken down and moved modularly, it is not practical for quick and efficient lifting of a fallen person at any location where the device is not already positioned. U.S. Pat. No. 5,669,086 describes a highly portable system based on inflating a stack of bags to lift a patient from a fallen position. The inflating bags have no means for restricting the patient's movement and position as the pressure in the bags increase (similar to movement on an air mattress), making it very precarious for a patient who has suffered injuries (or an elderly person with poor balance) to “ride” the bags to a normal sitting or standing position. Design Patent #D337,443 does not embody any form of wheels for transport, nor does it disclose any form of support frame or structure to prevent a patient from falling out of the chair or to ease the patient's rise out of the chair when in an elevated position. Prior art such as U.S. Pat. No. 4,157,593 does not provide means for lifting a fallen victim from the floor; rather it only provides means for transporting a person from a chair or a bed to another surface of equal height.

The Lift Wheelchair disclosed in U.S. Pat. No. 7,055,840 addresses some of the deficiencies noted in previous inventions. The device is highly mobile and capable of supporting a patient through all phases of use. However, the device is impractical because it requires a considerable amount of effort in loading or unloading the user from the seat. It is required for the user to slide up (or down) a ramp from the floor surface and onto the seat portion. For an elderly, overweight or non-ambulatory person, this task may prove very difficult. U.S. Pat. No. 6,430,761 discloses a small, collapsible and highly transportable patient lift. However, the patent lacks any method with which to safely restrain an injured patient and not apply direct pressure to areas in direct contact with the seating sling. In addition, it also lacks any place that a patient could use as a handhold during the standing or sitting process. The mobile self-recovery lift chair disclosed in U.S. Pat. No. 6,935,648, like other similar lifting seat concepts, carries the full weight of the patient (and the seat mechanisms) on the rear of the seat frame. Patients that are of considerable heft may overtax these lifting mechanisms and misalign the seat with the lift, causing system malfunction, or possibly human injury if the seat collapses.

The present invention addresses and dramatically improves upon all of the above-mentioned concerns within the prior art patents, resulting in a mobile, efficient, and highly usable patient lifting and transporting device.

### BRIEF SUMMARY OF THE INVENTION

The portable, powered chair lift disclosed in the present invention provides a method for a single attendant to effortlessly lift and transport a non-ambulatory patient. Regardless of the size, weight, age, or physical condition of the patient or the size of the attendant, any fallen person can be lifted from the floor to any height up to 39 inches. When the lifting seat is at the desired height, the unit serves as a functional transportation device, providing means for delivering a fallen person from the floor to a chair, bed, or simply to a standing position.

Unlike the prior art discussed in the background of the invention, the present invention uses a three point contact system to ensure that the seat is capable of handling even the heaviest of patients without damage to the seat's alignment. The seat is secured within an external framework made of a high strength material such as tubular aluminum or carbon fiber. Attached to the framework are two linear bearings and rails, which are attached to the right and left sides of the lifting seat. On the rear of the seat is mounted an actuator, which aligns and drives the seat. The seat lifting function is moderated with a hand controller that can be operated either by the patient or the attendant. The seat has an integrated harness system that prevents any patient from falling out of the seat during use. In addition, the seat's framework provides a strong and stable area for the patient to grasp during transport or during seat ingress or egress.

The framework is mounted on large diameter casters, allowing for easy rolling of the device to any desired destination. The casters lock, preventing any movement while the lifting seat is operating. Once the seat is lifted to the desired height, the casters can be unlocked and an attendant can transport the patient to their intended destination by applying force to a horizontal bar at the rear of the framework, resembling the handgrip bar on a shopping cart.

The present invention is powered by an on-board battery system. In the event the battery loses charge, there is a manual hand crank, which can be used to raise and lower the seat.

All electrical and mechanical portions of the present invention are sealed and enclosed to ensure that the device can be efficiently cleaned and sterilized before or after use. The seat cover can be removed and replaced without the need for instructions or tools.

### BRIEF DESCRIPTION OF THE SEVERAL VIEWS OF THE DRAWINGS

FIG. 1. Front Elevation View of Invention.

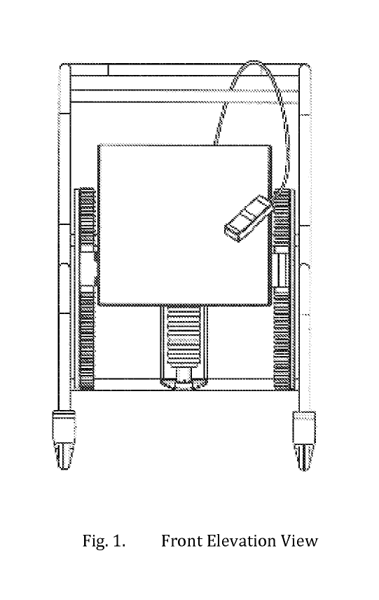

FIG. 2. Rear Elevation View of Invention.

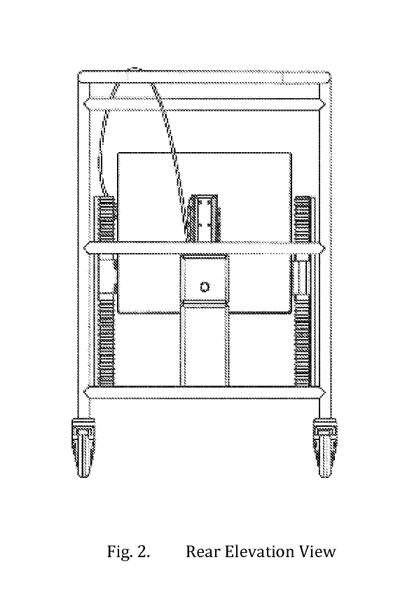

FIG. 3. Right Elevation View of Invention.

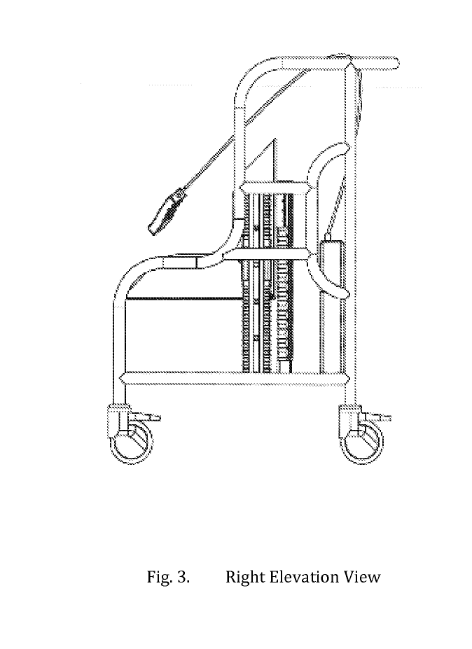

FIG. 4. Left Elevation View of Invention.

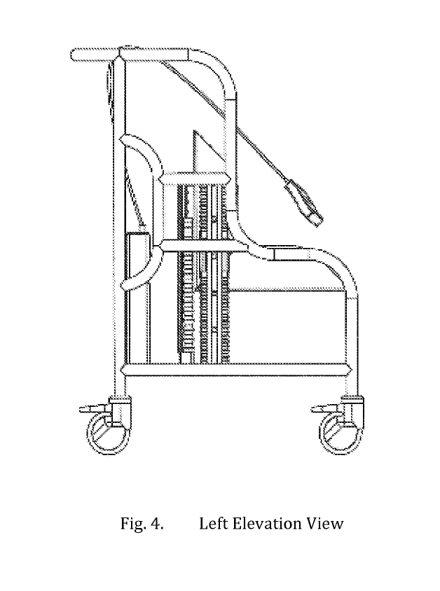

FIG. 5. Top Plan View of Invention.

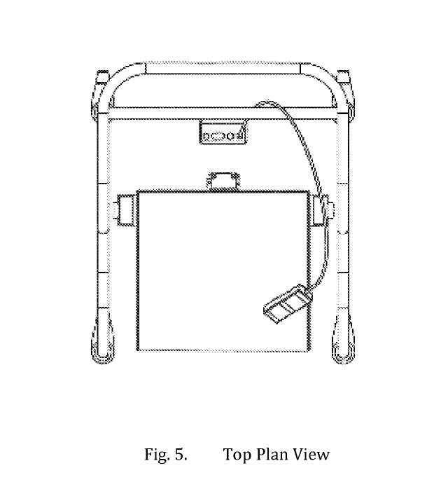

FIG. 6. Front Right Perspective View of Invention.

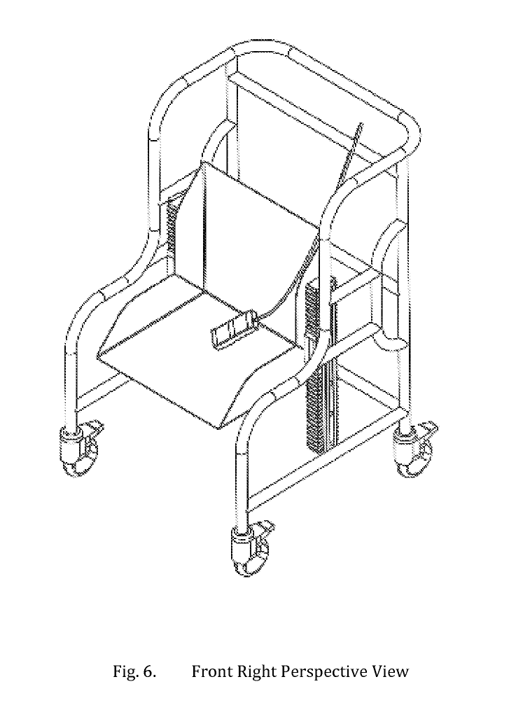

FIG. 7. Rear Right Perspective View of Invention.

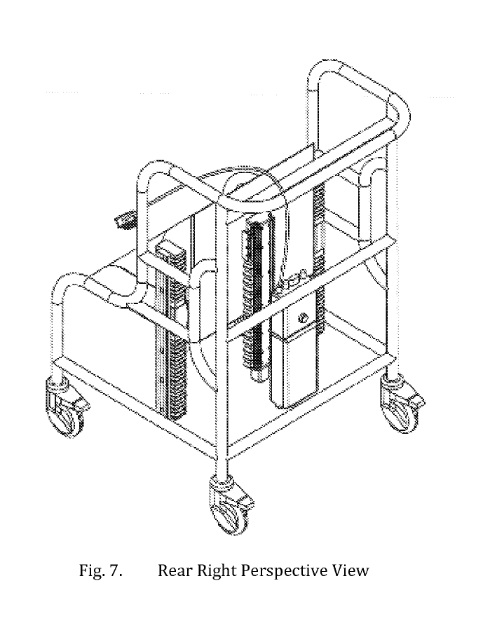

FIG. 8. Parts Reference of Invention Front Perspective.

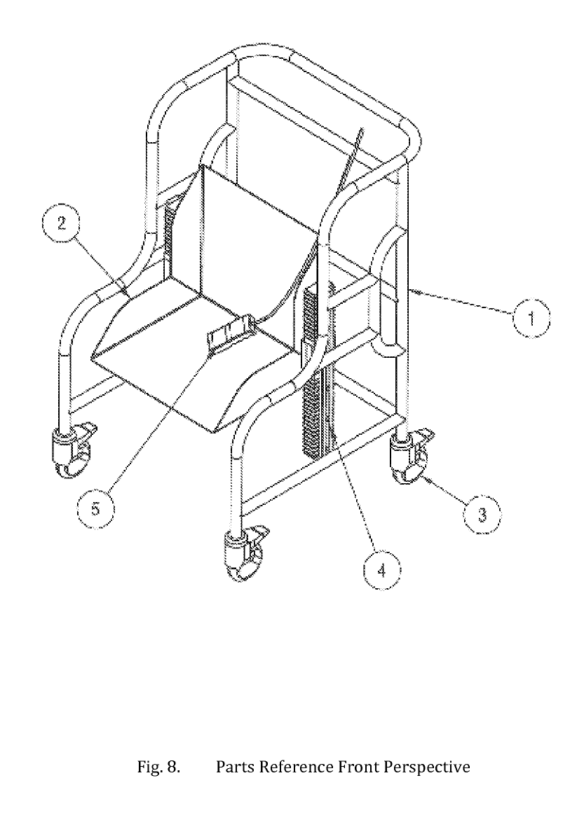

FIG. 9. Parts Reference of Invention Rear Perspective.

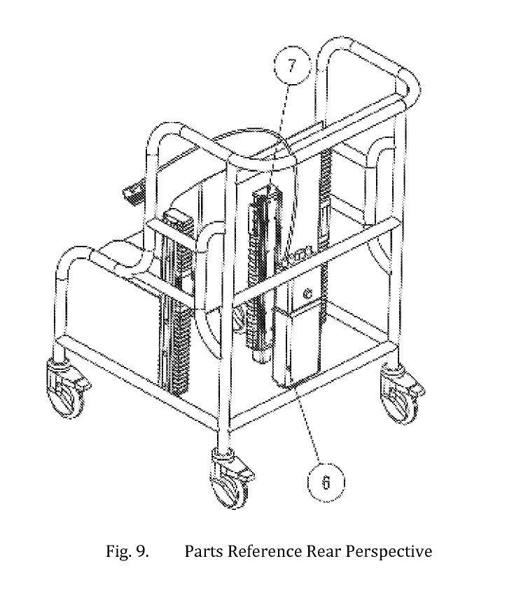

FIG. 10. Drawing Parts List.

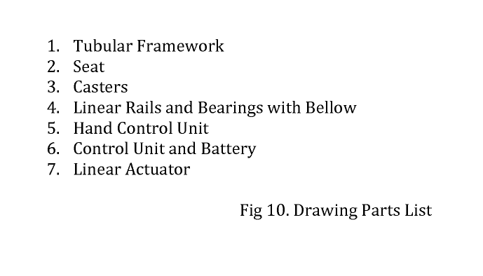

### DETAILED DESCRIPTION OF THE INVENTION

The portable, powered chair lift is described in its entirety below.

The present invention is comprised of multiple pieces attached together to create a final assembly. The assembly is made up, at a minimum, of the following components: a tubular framework, rolling mechanisms such as casters, a seat, linear bearings and rail, a linear actuator, a control unit which drives the linear actuator, a power source, and a handheld controller to operate the unit. Optional items may be added to create additional functionality or increase safety.

The chair lift's framework is most often formed of tubular aluminum with an outer dimension of approximately two inches, allowing for all portions of the framework to be used as a handhold by either the patient or the caregiver. In some instances, the framework can be made of different materials such as carbon fiber or steel, or any combination thereof. The bends and corners of the framework are formed in such a way that there are no sharp or protruding edges that might injure the patient or the caregiver during use of the chair lift. The framework has dimensions such that it will fit through a standard residential doorway. All of the components of the chair lift are mounted on the inside of the framework allowing the framework to act as a bumper and guard in the event of collision with a wall or other external surface.

The chair lift's framework is mounted above a caster at each corner of the invention. Each of the four casters has full directional freedom. Optionally, the two rear casters can be restricted such that they will only roll in a direction forward or backward relative to the unit. The casters are of such height that they will not have trouble traversing items such as small cords, small rocks, or pieces of trash. When the present invention is being used to lift a patient, all four casters can be locked, ensuring that the platform is safe and stable.

The lift requires a chair surface with which to lift and safely secure a patient during transport. The seating surface is comprised of a lower seating surface and a seat back. The thickness of the lower surface is minimal, ensuring ease of use when sliding the seat under the patient (or, if capable, the patient sliding onto the seat). The seat base is removable. This allows for the base to be removed and inserted beneath a patient, thus allowing the lifting device to be moved and again engaged with the seat base for lifting purposes. In other circumstances, the base can be removed when a patient is lowered on to a desired surface such as a toilet or wheelchair. The seat base can be installed into the framework at a desired angle, allowing for the base to tilt to one side so as to not further injure a patient who has an ailment on one side of their posterior. An additional use of the lower seating surface is as a standing lift for a patient. If a patient can walk or step on to the lower seating surface when placed on ground level, the lift can be used to help a patient overcome a stair step. The patient seat is connected on each side to a linear bearing and at the back to a linear actuator. The linear bearings ensure that the seat raises and lowers safely, providing support and guidance during vertical movement. Additionally, the linear bearings serve to eliminate any strength or misalignment issues caused by the seat being solely supported and cantilevered out from a rear support structure. Each of the linear bearings and rail is encased in bellows, ensuring that there are no openly visible parts. The bellows allow for a quick and easy cleaning process. The linear actuator is positioned on the back of the seat back, providing the movement of the seat in a vertical direction. The seat harness is secured through the seat back, reducing complexity and possibility of entanglement.

In an alternative form, the seat base is hinged along the rear edge with the seat back, allowing for the seat base to be pivoted to a variety of angles. This variable pitch seat base serves multiple purposes. When the nose of the seat is lower than the rear of the seat, the seat base can be used as a sort of ramp, which when inserted beneath a prone person and lifted, will enable the fallen person to reach an upright seating position. For those patients having difficulty sliding back and fully engaging onto the seat base, the base can be tilted slightly nose-up, allowing for patient to more effectively slide back into the seated position ensuring the patient's back makes contact with the seat back. Once a person is safely restrained and seated, the angle of the seat base can be adjusted (raising the nose of the seat higher than the rear of the seat) to ensure the safety and comfort of the patient and retain the person from falling during transport. Additionally, if the seat is in a raised position, the seat bottom can be tilted downward to help a patient sitting on the seat transition to a standing position.

An additional alternative form involves the replacement of the rigid, low profile seat base with a flexible and adaptable sling.

The portable powered chair lift is powered by either direct current or alternating current. The on-board control unit houses the necessary transformer to ensure that the linear actuator can be driven by either power source. The direct current power source is housed in the form of a rechargeable battery. The battery charging mechanism is also housed in the control unit, facilitating ease of use for the caregiver. The caregiver has the ability to use the system solely on battery power, or, if the unit has been used to the point of battery exhaustion, it can be plugged into a standard 110-volt outlet and used. If for any reason the power sources fail, the seat can be adjusted with a back-up manual raising/lowering crank system located on the rear of the seat back.

The lifting and lowering of the seat is operated using a wired hand controller. The controller is wired to the control unit, which, in turn, provides the needed power to the actuator. The wired controller has a length of wire long enough such that either the patient or the caregiver can operate it from a seated position on the floor. In an alternative embodiment, the hand controller is wireless. The controller has methods for the user to specify the speed of seat movement and whether or not it should stop at a predetermined height. It also has a method for the user to specify when to start and stop the vertical movement and the direction of seat travel.

All portions of the present invention are fully enclosed and able to be quickly and easily wiped down and disinfected.

The use of the present invention is straightforward. The caretaker wheels the device to a position behind the fallen person. If the person cannot sit up on their own, the seat of the device can be lowered to the level of the floor (seat base is flush with floor level) and inserted beneath the head, neck, and shoulders of the fallen person. The caretaker initiates the lifting of the seat, which in turn, lifts the upper torso of the fallen person, enabling the person to sit in an upright position. Once in an upright sitting position, the seat is lowered to ground level. If the fallen person is capable of sliding backwards onto the seating surface, the device is held stationary while the fallen person gets into position. If the fallen person is not capable of sliding backward, the seat base can be removed and inserted beneath the sitting person. Once properly situated on the surface, the device framework can slide forward, engaging the lower seat surface. Once the seat surface is re-engaged to the framework, the lifting of the fallen person can commence. Alternatively, the device as a whole can be moved forward, sliding the seat bottom under the fallen person while the seat framework wraps around either side of the person. The framework can then be used as a support means for the fallen person.

Once the sitting person is properly positioned on the seating surface, they are secured into the seat with a safety harness or lap belt built into the seat. When the person is adequately positioned, the seat can be lifted to the desired height. Once at the desired height, the fallen person can be transported to any desired location. At the desired location, the previously fallen person can be transferred to a bed or chair. Alternatively, the previously fallen victim can simply stand and walk off after being lifted from a fallen position.

What is claimed is:

1. A portable human lifting device for lifting and transporting fallen persons comprising:
a. A tubular framework consisting of horizontal and vertical support members around three sides of device, said framework having rounded, non-sharp corners of such a diameter that a human can grasp framework comfortably;
b. Rolling casters mechanically attached to the underside of said framework, each caster having 360 degree rotational freedom and capability to be locked in such a way that motion is restricted to a particular plane or all motion can be restricted;
c. A portable power source which can be plugged in to a standard alternating current source for recharging;
d. An electronic control unit capable of regulating the charging of said power source in addition to regulating power provided to the linear actuation unit;
e. A wired handheld remote control operation unit providing the means with which to regulate the direction, speed, and height of seat travel;
f. A linear actuation driving unit mechanically attached to said tubular framework and modular seat back providing necessary power to lift and lower modular seat in a vertical direction;
g. Two linear bearings and rail mechanically affixed to said tubular framework and side portions of modular seat;
h. A modular seat formed of two distinct portions, a seat back with harness and a low profile removable seat bottom.
i. Modular seat having capability of resting flush on floor and being vertically elevated to a height twice as high as a standard seating height.

2. The lifting device as disclosed in claim 1, comprising a modular seat, providing means with which one may adjust alignment, orientation, and angle of seat base.

3. The lifting device as disclosed in claim 1, comprising a non-powered, manual means with which to raise or lower seat.

4. The lifting device as disclosed in claim 1, comprising all mechanical and electrical units in enclosed and sealed boxes for cleaning purposes.

5. The lifting device as disclosed in claim 1, additionally comprising a seat base which is mechanically hinged to the seat back allowing for adjustment of seat base pitch relative to a horizontal position.

6. The lifting device as disclosed in claim 1, comprising a wireless remote control operation unit.

7. The lifting device as disclosed in claim 1, comprising having lower removable horizontal supports on rear framework of device.
